(19) United States
(12) Patent Application Publication
(10) Pub. No.: US 2026/0195476 A1
(43) Pub. Date: Jul. 9, 2026

(54) CONTENT SCREENING USING RETRIEVAL-ORIENTED CONTEXT AUGMENTED LANGUAGE MODELS

(71) Applicant: GOOGLE LLC, Mountain View, CA (US)

(72) Inventors: Apoorv Kulshreshtha, Mountain View, CA (US); Karthik Lakshmanan, San Ramon, CA (US)

(21) Appl. No.: 19/410,017

(22) Filed: Dec. 5, 2025

Related U.S. Application Data
(60) Provisional application No. 63/741,506, filed on Jan. 3, 2025.

(51) Int. Cl. G06F 21/62

(52) U.S. Cl. CPC G06F 21/6227

(57) ABSTRACT

Content screening using retrieval-oriented context augmented language models includes a dynamic reasoning analysis system screening a unit of content by obtaining current dynamic reasoning analysis input data, wherein the current dynamic reasoning analysis input data includes a content identifier for the unit of content, obtaining a content screening data structure, identifying a planner language model trained using planner training data, wherein augmentation data sources are available to the dynamic reasoning analysis system. Screening the unit of content includes obtaining screener language model input data including the current augmentation data from the content screening data structure, sending the screener language model input data to the screener language model, obtaining, from the screener language model, in response to the screener language model input data, content screening data for the unit of content, wherein the content screening data includes data indicating an action for the unit of content, and performing the action.

### CROSS-REFERENCE TO RELATED APPLICATION(S)

This application claims priority to and the benefit of U.S. Provisional Application Patent Ser. No. 63/741,506, filed Jan. 3, 2025, the entire disclosure of which is hereby incorporated by reference.

### BACKGROUND

Digital content, such as text content, audio content, images, and video can be hosted, or stored, such as on a server or content storage and distribution system, such as using electronic communication via an electronic communication network, such as the Internet. Client devices, which may be operated by users, may upload images and videos to content storage and distribution systems, and may access images and videos stored by content storage and distribution systems.

### SUMMARY

Disclosed herein are aspects of systems, methods, and apparatuses for content screening using retrieval-oriented context augmented language models.

An aspect is a method for content screening using retrieval-oriented context augmented language models. Content screening using retrieval-oriented context augmented language models may include content screening, by a dynamic reasoning analysis system, a unit of content. The content screening may include obtaining current dynamic reasoning analysis input data, wherein the current dynamic reasoning analysis input data includes a content identifier for the unit of content, obtaining a content screening data structure, identifying a planner language model trained using planner training data, wherein augmentation data sources are available to the dynamic reasoning analysis system, and wherein at least some data available from the augmentation data sources differs from the planner training data, and one or more iterations of obtaining augmentation data. A respective iteration of obtaining augmentation data includes generating planner language model input data in accordance with the current dynamic reasoning analysis input data and data from the content screening data structure, sending the planner language model input data to the planner language model, obtaining, from the planner language model, in response to the planner language model input data, planner language model output data, determining whether the planner language model output data includes an end of planning token, in response to determining that the planner language model output data omits the end of planning token, obtaining, in accordance with the planner language model output data, current augmentation data from a current augmentation data source from the augmentation data sources, wherein the planner language model output data indicates the current augmentation data source, including the current augmentation data in the content screening data structure, and in response to determining that the planner language model output data omits the end of planning token, identifying a screener language model trained using second training data, wherein at least some data available from the augmentation data sources differs from the second training data. The content screening may include obtaining screener language model input data including the current augmentation data from the content screening data structure, sending the screener language model input data to the screener language model, obtaining, from the screener language model, in response to the screener language model input data, content screening data for the unit of content, wherein the content screening data includes data indicating an action for the unit of content, and performing the action.

An aspect is a method for content screening using retrieval-oriented context augmented language models. Content screening using retrieval-oriented context augmented language models may include content screening, by a dynamic reasoning analysis system, a unit of content. The content screening may include obtaining current dynamic reasoning analysis input data, wherein the current dynamic reasoning analysis input data includes a content identifier for the unit of content, obtaining a content screening data structure, identifying a planner language model trained using planner training data, wherein augmentation data sources are available to the dynamic reasoning analysis system, and wherein at least some data available from the augmentation data sources differs from the planner training data, one or more iterations of obtaining augmentation data, wherein a respective iteration of obtaining augmentation data comprises including current augmentation data in the content screening data structure, obtaining screener language model input data including the current augmentation data from the content screening data structure, sending the screener language model input data to a screener language model, obtaining, from the screener language model, in response to the screener language model input data, content screening data for the unit of content, wherein the content screening data includes data indicating an action for the unit of content, and performing the action.

An aspect is a dynamic reasoning analysis system. The dynamic reasoning analysis system includes a processor, and a memory storing instructions that, when executed by the at least one processor, cause the system to screen content, wherein, to screen the content, the processor executes the instructions to obtain current dynamic reasoning analysis input data, wherein the current dynamic reasoning analysis input data includes a content identifier for the unit of content, obtain a content screening data structure, identify a planner language model trained using planner training data, wherein augmentation data sources are available to the dynamic reasoning analysis system, and wherein at least some data available from the augmentation data sources differs from the planner training data, iteratively obtain augmentation data, wherein, to perform a respective iteration, the processor executes the instructions to include current augmentation data in the content screening data structure, obtain screener language model input data that includes the current augmentation data from the content screening data structure, send the screener language model input data to a screener language model, obtain, from the screener language model, in response to the screener language model input data, content screening data for the unit of content, wherein the content screening data includes data indicating an action for the unit of content, and perform the action.

An aspect is non-transitory computer-readable storage medium storing instructions that, when executed by at least one processor, cause the at least one processor to perform content screening using retrieval-oriented context augmented language models. Content screening using retrieval-oriented context augmented language models may include content screening, by a dynamic reasoning analysis system, a unit of content. The content screening may include obtaining current dynamic reasoning analysis input data, wherein the current dynamic reasoning analysis input data includes a content identifier for the unit of content, obtaining a content screening data structure, identifying a planner language model trained using planner training data, wherein augmentation data sources are available to the dynamic reasoning analysis system, and wherein at least some data available from the augmentation data sources differs from the planner training data, and one or more iterations of obtaining augmentation data. A respective iteration of obtaining augmentation data includes generating planner language model input data in accordance with the current dynamic reasoning analysis input data and data from the content screening data structure, sending the planner language model input data to the planner language model, obtaining, from the planner language model, in response to the planner language model input data, planner language model output data, determining whether the planner language model output data includes an end of planning token, in response to determining that the planner language model output data omits the end of planning token, obtaining, in accordance with the planner language model output data, current augmentation data from a current augmentation data source from the augmentation data sources, wherein the planner language model output data indicates the current augmentation data source, including the current augmentation data in the content screening data structure, and in response to determining that the planner language model output data omits the end of planning token, identifying a screener language model trained using second training data, wherein at least some data available from the augmentation data sources differs from the second training data. The content screening may include obtaining screener language model input data including the current augmentation data from the content screening data structure, sending the screener language model input data to the screener language model, obtaining, from the screener language model, in response to the screener language model input data, content screening data for the unit of content, wherein the content screening data includes data indicating an action for the unit of content, and performing the action.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device.

FIG. 2 is a diagram of a computing and communications system.

FIG. 3 is a process flow diagram of an example of content screening using retrieval-oriented context augmented language models.

FIG. 4 is a process flow diagram of an example of obtaining content screening data.

### DETAILED DESCRIPTION

A content hosting system (content storage and distribution system) may host thousands, millions, or billions of units of content, such as videos, images, audio clips, or comments uploaded, or otherwise provided, to the content hosting system. Content hosting systems may restrict, limit, prevent, or otherwise control the availability of content thereon in accordance with one or more defined policies, procedures, manuals, or guidelines (hereinafter “policies” for simplicity). To implement such policies, content hosting systems may utilize manual, or human, reviewers to evaluate, screen, or review content and identify appropriate actions, such as allowing, limiting, or preventing access to the content. The review of content in accordance with such policies may include evaluating substantial contextual data, such that content review may utilize substantial human and computing resources. For example, multiple policies may be concurrently applicable, and a respective policy may be relatively long, such as twenty pages. Furthermore, other contextual factors, such as language, subject matter, user data, or historical data, may be relevant such that reviewing, or screening, content may include identifying relevant contextual factors and identifying applicable policy provisions in accordance with the relevant contextual factors. Human reviewers may utilize complex contextual reasoning, which may include accessing one or more data sources, to determine relevant portions of the content to evaluate and to determine relevant contextual factors, data, and applicable policies, and provisions thereof, to apply.

Machine learning models, such as large language models, are trained using discrete training datasets to perform specific tasks, such as natural language processing, including text generation, translation, summarization, and question answering. For example, a generative machine learning model, such as a language model, such as a large language model, may receive a prompt including input data, such as in input text string, and may generate and output response data, such as text, responsive to the input. Training a model includes the model adjusting weights or parameters thereof in accordance with the training data, such that the output of a model responsive to an input, or prompt, is probabilistic, wherein the probabilities are influenced by the training data. The performance, or accuracy, of a machine learning model is positively correlated with the size of the training dataset. To improve the accuracy of machine learning models massive training datasets are used to train the models. Although large, such training datasets are limited, such that some information is absent from, or underrepresented in, the training datasets, and is unavailable to, or underrepresented in, the trained models, limiting the accuracy of the model. For example, data generated after a model is trained is unavailable to the model. In another example, some data may be restricted, or prevented, from inclusion in training datasets and is unavailable to the model.

To improve the accuracy of machine learning models, retrieval-augmented generation models, or systems, combine a trained machine learning model with an information retrieval component that obtains information that is absent from, or underrepresented in, the training data or otherwise unavailable to, or underrepresented in, the model, from specified augmentation data sources. The data obtained by the information retrieval component is included with the input to the model as context, to augment the data on which the model was trained, which improves the model accuracy in responding to the input. Limitations on the availability and content of the augmentation data sources and the amount of augmentation data that may be included with the input to the model limit the accuracy of the retrieval-augmented generation models. In some retrieval-augmented generation models the information retrieval component is manually configured to obtain augmentation data from a designated augmentation data source. The improvement in the accuracy of a retrieval-augmented generation model, relative to the model thereof in the absence of augmentation data, is positively correlated with the relevance of the augmentation data with respect to the input or task, the conciseness of the augmentation data, and the completeness of the augmentation data. Retrieval-augmented generation models may have limited utility, or accuracy, for some tasks, such as screening, evaluating, or reviewing, content, such as content hosted by a content hosting system, which include utilizing complex contextual reasoning to identify relevant augmentation data.

described herein includes screening, evaluating, or reviewing, content, such as content hosted by a content hosting system, by a dynamic reasoning analysis system that includes a retrieval-augmented language model in combination with a machine learning model, which may be a large language model, trained to identify a relevant subset of available augmentation data sources, to obtain highly relevant augmentation data for the input to the retrieval-augmented language model. The dynamic reasoning analysis system may automatically screen content and perform appropriate actions with respect thereto, or may output relevant content screening data, which may include the augmentation data, or a portion or portions thereof, for presentation to a human reviewer.

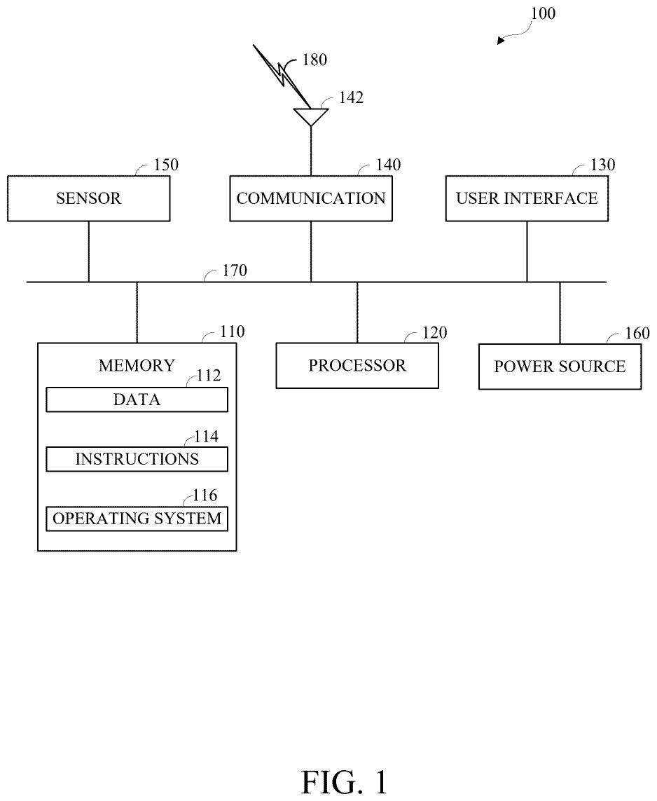

FIG. 1 is a block diagram of an example of a computing device 100. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown as a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 may be, or may include, input data, encoded data, decoded data, or the like. The instructions 114 can include directions, such as code, for performing, or causing or facilitating the performance of, any method, or any portion or portions thereof, disclosed herein. The instructions 114 can be realized in hardware, software, or any combination thereof. For example, the instructions 114 may be implemented as information stored in the memory 110, such as a computer program or application, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

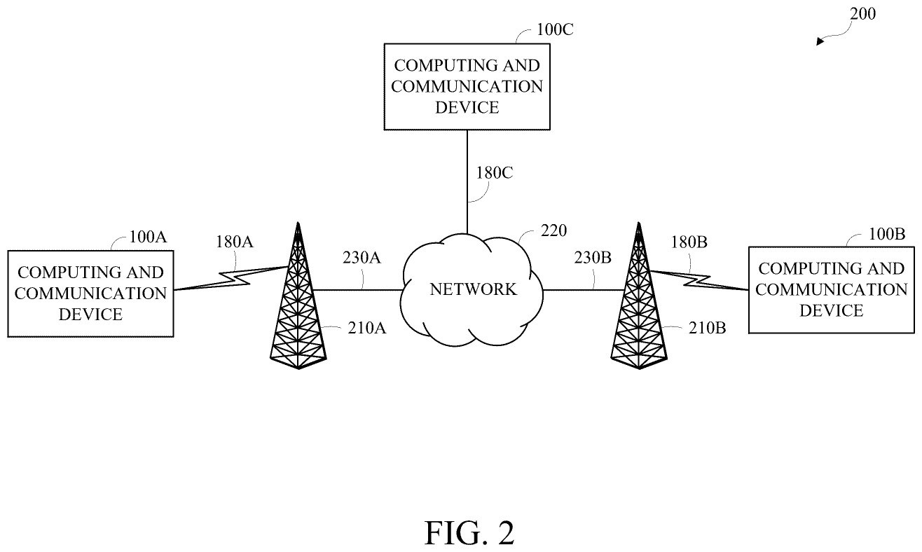

FIG. 2 is a diagram of a computing and communications system 200. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some or all of the functions of a user device, or some or all of the functions of a server and a user device. For example, the server computing and communication device 100C may receive, process, such as encode, process, store, transmit, or a combination thereof data, such as audio data or video data, and one or both of the computing and communication device 100A and the computing and communication device 100B may receive, process, such as decode, process, store, present, or a combination thereof the data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store data, such as encoded data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

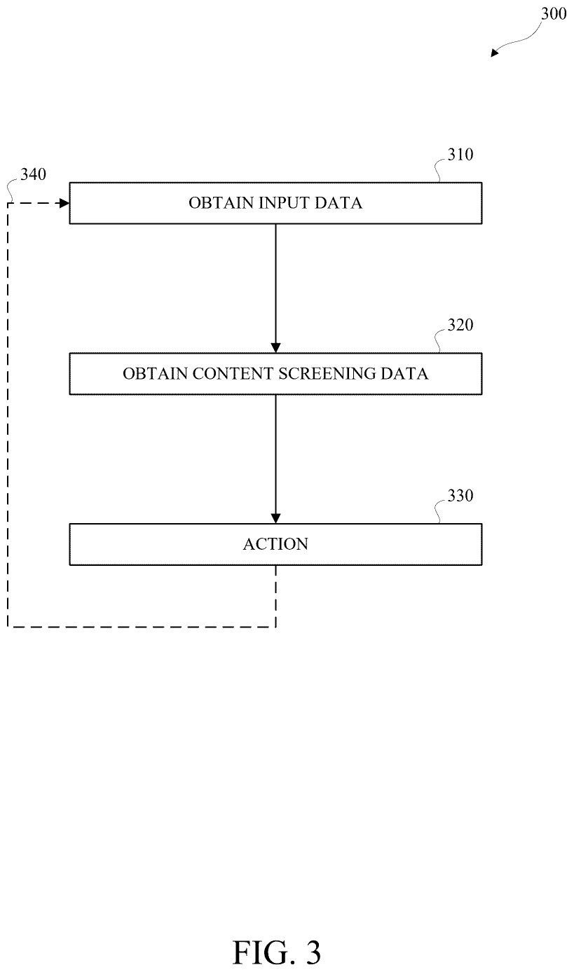

FIG. 3 is a process flow diagram of an example of content screening using retrieval-oriented context augmented language models 300. Content evaluation using retrieval-oriented context augmented language models 300 may be implemented in a dynamic reasoning analysis system, which may include one or more computing devices or systems, such as one or more of the computing device 100 shown in FIG. 1 or one or more of the computing and communication device 100A, 100B, 100C shown in FIG. 2.

In some implementations, the dynamic reasoning analysis system may be included in, may include, or may be operatively associated with, a content hosting system, or multiple content hosting systems.

Content screening, or evaluation, using retrieval-oriented context augmented language models 300 includes automatically, or semi-automatically, screening, evaluating, or reviewing, a unit of content (content entity), or units of content, to determine, or identify, content screening data for the unit of content, or respective content screening data for respective units of content. In some implementations, the content screening data indicates an action for the unit of content. For example, the action may be a label to apply to the unit of content. In another example, the action may be to delete or remove the unit of content from a content hosting system, or otherwise render the unit of content inaccessible via the content hosting system. In some implementations, the action may include including data in the content hosting system indicating that the unit of content is inaccessible. In some implementations, the action may include enabling access to the unit of content via the content hosting system.

In some implementations, the dynamic reasoning analysis system includes, or implements, an interface, such as an application programming interface (API). In some implementations, the dynamic reasoning analysis system, or one or more portions thereof, may be implemented, or operated, by a server. In some implementations, the dynamic reasoning analysis system includes one or more, such as multiple concurrent, processes, threads, or kernels, which may be uniquely identifiable by a respective process, thread, kernel, or session identifier. In some implementations, the dynamic reasoning analysis system includes a primary, or top-level, process or kernel that controls, coordinates, or both, one or more sub-processes or sub-kernels.

The dynamic reasoning analysis system includes, accesses, or both, multiple distinct available data sources (retrieval backends, embedding datastores, databases, structured knowledge bases), or one or more interfaces, such as application programming interfaces (APIs), or query interfaces, thereof. Data sources other than the data sources described herein may be used. One or more of the data sources may be publicly accessible. One or more of the data sources may be a controlled access system. Access to one or more of the data sources may be limited to the dynamic reasoning analysis system.

The data sources may include an internet search interface of an internet search system. The dynamic reasoning analysis system may send, transmit, or otherwise make available, to the internet search interface, request data indicating a request, or instruction, to search the internet, or one or more portions thereof, such as portions indexed by the internet search system, for data.

The data sources may include a content hosting search interface of the content hosting system, or content hosting systems, or respective content hosting search interfaces of the content hosting systems. The dynamic reasoning analysis system may send, transmit, or otherwise make available, to the content hosting search interface, request data indicating a request, or instruction, to search the content hosting system for content. In some implementations, the request includes an identifier of the content. For example, the content may be a video, the identifier may identify the video, and the dynamic reasoning analysis system may obtain the video, or data related to, or associated with, such as in the content hosting system, the video, from the content hosting system, such as from a video application programming interface (Video API) thereof, in response to the request. In some implementations, the request includes a search query and dynamic reasoning analysis system obtains the content, such as one or more videos, responsive to the search query. In some implementations, the request includes a channel identifier that identifies a channel, wherein the channel includes content, such as videos, or data indicating the content, and the dynamic reasoning analysis system obtains the content included in, or referenced by, the channel. In some implementations, the request data may indicate one or more criteria or parameters for obtaining the content from the channel, such as a number, count, or cardinality of videos to obtain, or an indication to obtain the content in accordance with recency data included in the channel data. In some implementations, content is a channel, and the dynamic reasoning analysis system obtains channel data for the channel, such as in response to a request that indicates an identifier of the channel or a search query, wherein the channel is responsive to the search query. In some implementations, the content is a playlist, and the dynamic reasoning analysis system obtains playlist data for the playlist, such as in response to a request that indicates an identifier of the playlist or a search query, wherein the playlist is responsive to the search query.

The data sources may include a semantic search interface of a vector database of embeddings (vector database semantic search interface). The dynamic reasoning analysis system may send, transmit, or otherwise make available, to the semantic search interface, request data indicating a request, or instruction, to search the vector database of embeddings for data.

The data sources may include a retrieval interface of a comments, or chat, system (comment retrieval interface). The dynamic reasoning analysis system may send, transmit, or otherwise make available, to the retrieval interface, request data indicating a request, or instruction, to retrieve one or more comments, or chat data, from the comments, or chat, system, such as in accordance with a unique identifier indicated in the request. The available from the comment retrieval interface includes the text of a respective comment. In some implementations, the data available from the comment retrieval interface includes data, such as an account identifier, indicating the author of a respective comment. In some implementations, the data available from the comment retrieval interface includes data, such as a content identifier, a content type identifier, or both, indicating another unit of content associated with a respective comment, such as a video with respect to which the comment pertains.

The data sources may include a retrieval interface of an automated speech recognition system or a captions system (caption retrieval interface). The dynamic reasoning analysis system may send, transmit, or otherwise make available, to the retrieval interface, request data indicating a request, or instruction, to retrieve captions, or automatically recognized speech data, from the automated speech recognition system or a captions system, such as in accordance with an identifier, indicated in the request, of a video, or another context, associated with the captions, or automatically recognized speech data, such as a video identifier or a unique identifier. The captions, or automatically recognized speech data, may include temporal location data, such as one or more timestamps.

The data sources may include a retrieval interface for obtaining other previously determined annotations for the content, or one or more portions thereof, which may include categorization, or topic, data for the content, identifiers to organize the content, relevant keywords for the content, machine generated summaries for the content from other machine learning models, or a combination thereof.

The data sources may include a retrieval interface of a datastore, or system, that stores content screening instructions, policies, or both (policy repository). The dynamic reasoning analysis system may send, transmit, or otherwise make available, to the retrieval interface, request data indicating a request, or instruction, to retrieve content screening instructions, policies, or both, or one or more portions thereof, from the datastore. In some implementations, the policy repository may be a vector database of embeddings that indexes the policy data.

The data sources may include a retrieval interface of a coded-language repository. The dynamic reasoning analysis system may send, transmit, or otherwise make available, to the retrieval interface, request data indicating a request, or instruction, to retrieve coded-language data from the coded-language repository. Coded language is neutral natural language used in a negative way.

The data sources may include a retrieval interface of a repository of accounts data. The dynamic reasoning analysis system may send, transmit, or otherwise make available, to the retrieval interface, request data indicating a request, or instruction, to retrieve account data from the repository of accounts data. For example, the request may include an account identifier that indicates an account, such as a user, or creator, account. In some implementations, the account data indicates or includes activity data for the account. The activity data may include data indicating one or more policy violations associated with the account.

Account data may include data indicating one or more units of content, or a number, count, or cardinality thereof, uploaded, or otherwise provided, to the content hosting system in association with the account. Account data may include data indicating one or more units of content, or a number, count, or cardinality thereof, accessed from the content hosting system in association with the account. Account data may include data indicating one or more content interactions, such as content approval actions, content sharing actions, subscription actions, following actions, or the like, associated with the account. Account data may include data indicating content access data indicating a portion, or portions, of one or more units of content accessed from the content hosting system in association with the account. Account data may include data indicating an amount of time associated with accessing the content hosting system in association with the account. Account data may include data indicating content access data indicating one or more search terms, requests, or strings input into the content hosting system in association with the account.

The data sources may include a retrieval interface of a region-specific language repository. The dynamic reasoning analysis system may send, transmit, or otherwise make available, to the retrieval interface, request data indicating a request, or instruction, to retrieve region-specific language data from the region-specific language repository. The region-specific language data indicates words, phrases, symbols, images, sounds, or other data that has region-dependent meaning. Region-dependent meaning indicates meaning that differs among regions, or other determinable contexts.

The data sources may include a retrieval interface of a news repository. The dynamic reasoning analysis system may send, transmit, or otherwise make available, to the retrieval interface, request data indicating a request, or instruction, to retrieve news data from the news repository.

The data sources may include a retrieval interface of a multimodal understanding system, such a computer vision system. The dynamic reasoning analysis system may send, transmit, or otherwise make available, to the retrieval interface, request data indicating a request, or instruction, to retrieve multimodal understanding data from the multimodal understanding system.

The data sources may include a content type determination data source for looking up the content type of a unit of content, such as based on the content identifier for the unit of content. The content type may be a text content type, such as a text string. The content type may be an account data content type. The content type may be a content collection content type, such as a playlist or a channel. The content type may be a video content type. The content type may be an image content type. The content type may be an audio clip content type. Other types of content may be used.

The data sources may include a repository of language model prompt examples, such as few-shot examples, or a retrieval interface thereof. The dynamic reasoning analysis system may send, transmit, or otherwise make available, to the repository of few-shot examples, or the retrieval interface thereof, request data indicating a request, or instruction, to retrieve one or more few-shot examples, as described herein, from the repository of few-shot examples, or the retrieval interface thereof. In some implementations, the data sources may include a language model trained to output few-shot examples, such as in accordance with content type data, task data, or both.

The data sources may include a data structure, list, or other repository, of data indicating one or more language models available to, such as included in or accessible by, the dynamic reasoning analysis system.

In some implementations, the data sources may include a human to machine interface whereby the dynamic reasoning analysis system may obtain data input by a user of the dynamic reasoning analysis system responsive to a request from the dynamic reasoning analysis system.

Content evaluation using retrieval-oriented context augmented language models 300 includes obtaining current dynamic reasoning analysis input data (at 310), obtaining content screening data (at 320), and action (at 330). Content evaluation using retrieval-oriented context augmented language models 300 may include other aspects not expressly shown.

The dynamic reasoning analysis system obtains the current dynamic reasoning analysis input data (at 310).

In some implementations, the current dynamic reasoning analysis input data is user input data expressing a request for dynamic reasoning analysis.

In some implementations, the dynamic reasoning analysis system obtains the current dynamic reasoning analysis input data from a queue, or another collection or data structure, of pending dynamic reasoning analysis input data, such as automatically, such as in the absence of express user input data expressing a request for dynamic reasoning analysis.

In some implementations, obtaining the current dynamic reasoning analysis input data (at 310) includes obtaining data indicating a task, request, or question associated with the unit of content, such as the request for dynamic reasoning analysis.

The current dynamic reasoning analysis input data includes a content identifier (content ID) indicating a unit of content. The unit of content may be text content, such as a text string, account data, a content collection, such as a playlist or a channel, a video, an image, or an audio clip, or one or more portions thereof. Other types of content may be used.

In some implementations, obtaining the current dynamic reasoning analysis input data (at 310) includes obtaining content type data indicating the type of content (content type). In some implementations, the content type data is absent, or unavailable, from the current dynamic reasoning analysis input data.

In some implementations, the current dynamic reasoning analysis input data includes the unit of content. In some implementations, the unit of content is absent, or unavailable, from the current dynamic reasoning analysis input data.

In some implementations, the current dynamic reasoning analysis input data includes data indicating a portion of the unit of content, such as a segment of a video.

For example, the unit of content may be a video uploaded, or otherwise provided, to the content hosting system. In another example, the unit of content may be a text comment submitted by a user with respect to a video hosted by the content hosting system. In another example, the unit of content may be a playlist of videos hosted on the content hosting system.

In an example, the content identifier may be a text data unit identifier, wherein the text data unit identifier indicates a unit of text data that is the unit of content. In another example, the content identifier may be an account identifier that indicates an account, wherein account data for the account is the unit of content. The account data may be or include a user profile. In some implementations, the account data indicates or includes activity data for the account. In another example, the content identifier may be a content collection identifier that indicates a content collection, wherein the content collection is the unit of content. In another example, the content identifier may be a video identifier that indicates a video, wherein the video is the unit of content. In another example, the content identifier may be an identifier of a portion of a video, wherein the portion of the video is the unit of content. In another example, the content identifier may be an image identifier that indicates an image, wherein the image is the unit of content. In another example, the content identifier may be an audio clip identifier that indicates an audio clip, wherein the audio clip is the unit of content. In another example, the content identifier may be an identifier of a portion of an audio clip, wherein the portion of the audio clip is the unit of content.

In some implementations, the current dynamic reasoning analysis input data includes a process, thread, kernel, or session identifier.

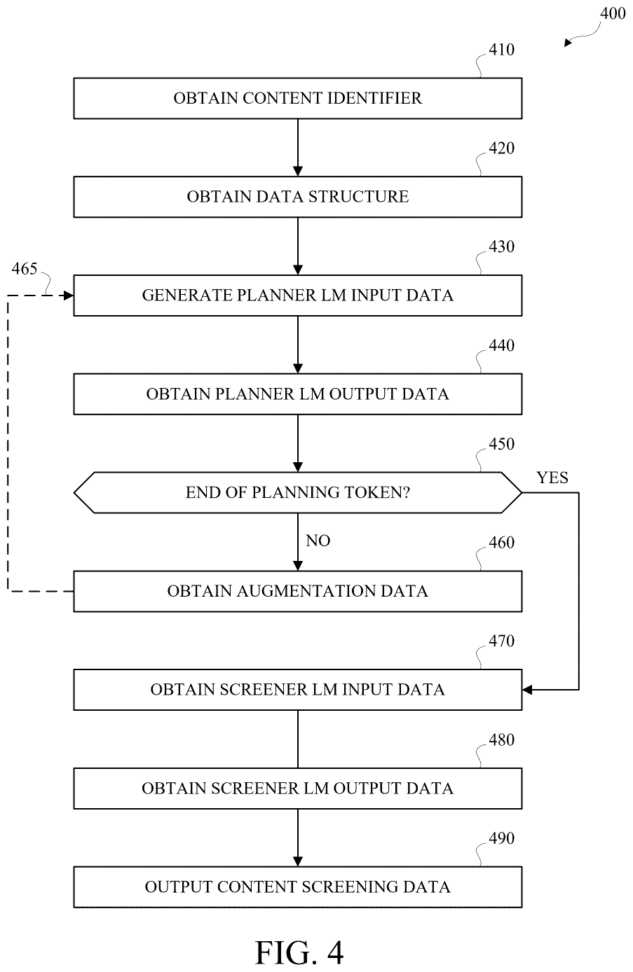

The dynamic reasoning analysis system obtains the content screening data (at 320) for the unit of content. An example of obtaining content screening data is shown in FIG. 4.

In some implementations, the content screening data includes a language model generated label for the unit of content.

In some implementations, the content screening data includes a language model generated natural language description of reasoning in support of the language model generated label.

In some implementations, the content screening data includes language model generated action data indicating an action for the unit of content.

In some implementations, the content screening data includes a language model generated natural language description of reasoning in support of the language model action data.

In some implementations, the content screening data includes confidence data (language model generated confidence data) indicating a determined, such a probabilistically, confidence or score, determined by the retrieval-augmented language model, for the content screening data, such as indicating a probability of accuracy of the content screening data.

In some implementations, the content screening data includes a language model generated natural language description of reasoning in support of the language model confidence data.

The dynamic reasoning analysis system performs, or implements, an action, or operation with respect to the current unit of content in accordance with the content screening data (at 330), such as an action indicated by the content screening data.

The dynamic reasoning analysis system determines whether to perform, or implement, an action, or operation, indicated in the content screening data, such as in accordance with the confidence data indicated in the content screening data.

In some implementations, the dynamic reasoning analysis system determines whether the confidence data indicates a confidence value that is greater than a defined threshold.

In some implementations, in response to determining that the confidence value is greater than the defined threshold, the dynamic reasoning analysis system performs, or implements, the action with respect to the unit of content in accordance with, or as indicated by, the content screening data.

In some implementations, the defined threshold is a rejection threshold, such as a ninety percent accuracy rejection threshold, the content screening data indicates rejection of the current unit of content, in response to determining that the confidence value is greater than the rejection threshold, the dynamic reasoning analysis system performs the action by removing the unit of content from the content hosting system. In some implementations, the defined threshold is a rejection threshold, the content screening data indicates rejection of the current unit of content, in response to determining that the confidence value is greater than the rejection threshold, the dynamic reasoning analysis system performs the action by including data in the content hosting system indicating that accessing the unit of content is prohibited.

In some implementations, the defined threshold is an approval threshold, such as a ninety percent accuracy approval threshold, the content screening data indicates approval of the current unit of content, in response to determining that the confidence value is greater than the approval threshold, the dynamic reasoning analysis system performs the action by omitting removing the unit of content from the content hosting system. In some implementations, the defined threshold is an approval threshold, the content screening data indicates approval of the current unit of content, in response to determining that the confidence value is greater than the approval threshold, the dynamic reasoning analysis system performs the action by including the unit of content in the content hosting system. In some implementations, the defined threshold is an approval threshold, the content screening data indicates approval of the current unit of content, in response to determining that the confidence value is greater than the approval threshold, the dynamic reasoning analysis system performs the action by including data in the content hosting system indicating that accessing the unit of content is permitted or approved.

In some implementations, the dynamic reasoning analysis system determines whether the confidence data indicates a confidence value that is less than a defined threshold, such as the rejection threshold or the approval threshold.

In some implementations, in response to determining that the confidence value is less than the defined threshold, the dynamic reasoning analysis system performs, or implements, the action with respect to the unit of content by outputting the content screening data, or a portion or portions thereof, for presentation to a user (reviewer) of the dynamic reasoning analysis system.

In some implementations, the action includes the dynamic reasoning analysis system outputting the content screening data, or a portion or portions thereof, for presentation to a user (reviewer) of the dynamic reasoning analysis system.

In some implementations, the content screening data includes the language model generated label for the unit of content, and the dynamic reasoning analysis system includes the language model generated label for the unit of content in the portion of the content screening data output for presentation to the user.

In some implementations, the content screening data includes the language model generated label for the unit of content and includes the language model generated natural language description of reasoning in support of the language model generated label, and the dynamic reasoning analysis system includes the language model generated label for the unit of content and the language model generated natural language description of reasoning in support of the language model generated label in the portion of the content screening data output for presentation to the user.

In some implementations, the content screening data includes the language model generated action data for the unit of content, and the dynamic reasoning analysis system includes the language model generated action data for the unit of content in the portion of the content screening data output for presentation to the user.

In some implementations, the content screening data includes the language model generated action data for the unit of content and includes the language model generated natural language description of reasoning in support of the language model generated action data, and the dynamic reasoning analysis system includes the language model generated action data for the unit of content and the language model generated natural language description of reasoning in support of the language model generated action data in the portion of the content screening data output for presentation to the user.

In some implementations, the dynamic reasoning analysis system includes a portion, or portions, of the augmentation data in the portion of the content screening data output for presentation to the user.

In some implementations, the action includes the dynamic reasoning analysis system labeling the unit of content in accordance with the language model generated label from the content screening data.

In some implementations, content screening using retrieval-oriented context augmented language models 300 is performed on a per-unit of content basis as indicated by the broken directional line (at 340) from performing an action (at 330) to obtaining input data (at 310).

FIG. 4 is a process flow diagram of an example of obtaining content screening data 400. Obtaining content screening data 400 may be implemented in a dynamic reasoning analysis system, which may include one or more computing devices or systems, such as one or more of the computing device 100 shown in FIG. 1 or one or more of the computing and communication device 100A, 100B, 100C shown in FIG. 2. For example, obtaining augmentation data as shown (at 320) in FIG. 3 may include obtaining content screening data 400 as shown in FIG. 4.

Obtaining content screening data 400 includes obtaining a content identifier (at 410), obtaining a content screening data structure (at 420), generating planner language model input data (at 430), obtaining planner language model output data (at 440), determining whether to obtain augmentation data (at 450), obtaining augmentation data (at 460), obtaining screener language model input data (at 470), obtaining screener language model output data (at 480), and outputting the content screening data (at 490). Obtaining content screening data 400 may include other aspects not expressly shown.

The dynamic reasoning analysis system obtains the content identifier (at 410). Obtaining content identifier may include obtaining current dynamic reasoning analysis input data indicating a unit of content, such as shown (at 310) in FIG. 3, except as is described herein or as is otherwise clear from context. For example, the current dynamic reasoning analysis input data may include a content identifier indicating the current unit of content. In some implementations, the current dynamic reasoning analysis input data may include task data indicating a task, or request, for the current unit of content.

In some implementations, the dynamic reasoning analysis system obtains express task data from the current dynamic reasoning analysis input data. The express task data includes natural language task description data for an expressly specified task for the unit of content. For example, the express task data may include the string “Is Rl6uzFj violating a harassment policy?”. In some implementations, the express task data is omitted, or absent, from the current dynamic reasoning analysis input data for a respective unit of content.

The dynamic reasoning analysis system obtains the content screening data structure (at 420), or an instance thereof, for obtaining the content screening data, such as by generating, allocating, or instantiating, the content screening data structure, or the content screening data structure instance. In some implementations, the content screening data structure may be a protocol buffer (protoBuff) data structure.

Prior to including data in the content screening data structure, the content screening data structure may omit or exclude data, other than structural data thereof, except as is described herein or as is otherwise clear from context.

Obtaining content screening data 400 includes obtaining language model generated data from one or more language models included in, or accessible by, the dynamic reasoning analysis system, such as a planner language model, a screener language model, both, or a combination thereof.

The planner language model (planner LM or PLM) is a trained, or tuned, model that is trained, or tuned, to obtain augmentation data, planning data for obtaining augmentation data, or both, for obtaining content screening data 400. The planner language model may be a large language model (LLM) or a small language model (SLM).

The planner language model is trained, or tuned, using planner training data (first training data). At least some data available from the data sources available in, or accessible by, the dynamic reasoning analysis system differs from the planner training data. The training, or tuning, using the planner training data is application, task, context, or domain, specific training, or tuning.

Prior to training, or tuning, the planner language model using the planner training data, the planner language model, or one or a portion or portions thereof, may be trained using an application-agnostic, task-agnostic, domain-agnostic, or otherwise diverse, training data set, such as a massive data set of text, such as books, articles, websites, software code, and the like, in one or more languages.

In some implementations, a planner language model is trained, or tuned, using parameter efficient tuning, or parameter efficient finetuning. Parameter efficient tuning includes training the model to learn, or update, a relatively small number, count, or cardinality of weights, or parameters, using the training data. In some implementations, parameter efficient tuning includes subset tuning, wherein the weights, or parameters, are subset of weights, or parameters, of the planner language model. In some implementations, parameter efficient tuning includes low rank adaptation tuning (LoRA), wherein the weights, or parameters, are added to, or combined with, the weights, or parameters, of the planner language model.

In some implementations, the planner language model is trained, or tuned, using full finetuning. Full finetuning includes training, or tuning, the weights, or parameters, of the planner language model to optimize performance with respect to the planner training data.

In some implementations, training, or tuning, the planner language model may be omitted, excluded, or skipped, and input to the planner language model may include zero shot, or few shot, prompt data including natural language instructions for responding to the planner language model input data.

In some implementations, the planner training data includes log data from a content screening, analysis, or review system, which may be similar to the dynamic reasoning analysis system, except as is described herein or as is otherwise clear from context. The log data may include data generated in accordance with manual, or user, input. For example, a user (reviewer) may use, or interact with, the content screening, analysis, or review system to screen, evaluate, or review a unit of content via a sequence or series of actions or operations and the content screening, analysis, or review system may generate the log data indicating the sequence or series of actions or operations, or one or more portions thereof. The log data may indicate the unit of content. In some implementations, the log data may include manually generated, or user input, data with respect to the actions or operations. The actions or operations may include obtaining, or accessing, data from one or more of the data sources (accessed data sources), and the log data may include data indicating the accessed data sources, or one or more accessed portions thereof. The log data may include a resolution, result, decision, or determination with respect to the content screening, analysis, or review, of the unit of content.

For example, the unit of content may be a video uploaded, or otherwise provided, to the content hosting system by a user (creator), the reviewer (user) may access one or more policies from the policy repository data source, such as a review policy with respect to reviewing videos or an acceptable use policy for the content hosting system, or one or more portions thereof, to review the video. The log data may indicate the policy, or policies, or the portion or portions thereof, accessed by the reviewer to review the video, which may include indicating the source of the policy data. The reviewer may access account data, such as account activity data, such as data indicating one or more previous violations of the policies, or the absence thereof, from the repository of accounts data. The log data may indicate the use of account data, which may include indicating the type of account data used, and which may indicate the source of the account data. The reviewer may access, or review, a portion, or portions, of the video. The log data may indicate the portion, or portions, of the video accessed, or reviewed, by the reviewer. In some implementations, the log data may include manual data, or user input data, indicating the portion or portions of the policy data, the account data, the video, or a combination thereof, indicated by the reviewer as relevant to reviewing the video. The log data may include data indicating a result, outcome, or resolution of reviewing the video, such as one or more actions taken with respect to the video, such as labeling the video in the content hosting system or removing the video from the content hosting system.

The log data with respect to reviewing a unit of content may be included as a positive training example in the planner training data. The planner training data may include multiple training examples, such as multiple examples of log data with respect to reviewing multiple units of content. In some implementations, the planner training data may include negative training examples, such as manually generated negative training examples.

In some implementations, one or more portions of the log data may be generated by, or using, the dynamic reasoning analysis system. For example, obtaining content screening data using the dynamic reasoning analysis system may include generating log data indicating the data source, or data sources, or a portion or portions thereof, accessed to obtain content screening data for a unit of content. The content screening data for the unit of content may indicate an action, or actions, for the unit of content. In some implementations, the action or actions for the unit of content may be identified, such as in the log data, as inaccurate, such as subsequent to obtaining the content screening data for the unit of content, and the log data may be identified as a negative training example. In some implementations, the data source, or data sources, or the portion or portions thereof, accessed to obtain the content screening data for the unit of content may be identified, such as in the log data, as inaccurate, inapplicable, or irrelevant, and the log data may be identified as a negative training example. In some implementations, the action or actions for the unit of content may be identified, such as in the log data, as accurate, such as subsequent to obtaining the content screening data for the unit of content, and the log data may be identified as a positive training example. In some implementations, the data source, or data sources, or the portion or portions thereof, accessed to obtain the content screening data for the unit of content may be identified, such as in the log data, as accurate, applicable, or relevant, and the log data may be identified as a positive training example.

In some implementations, the dynamic reasoning analysis system includes, or accesses, two or more planner language models (planner LMs), including a primary planner language model (primary planner LM) and one or more secondary, or task-specific, planner language models (secondary planner LMs).

The screener language model is a retrieval-augmented language model (RAG LM), which is a trained model, trained using second training data. The screener language model may be a large language model (LLM) or a small language model (SLM).

At least some data available from the data sources available in, or accessible by, the dynamic reasoning analysis system differs from the second training data. The second training data is application-agnostic, task-agnostic, domain-agnostic, or otherwise diverse, such as a massive data set of text, such as books, articles, websites, software code, and the like, in one or more languages. The screener language model is trained prior to a current instance or performance, such as for the current unit of content, of obtaining content screening data 400. Some data included in, or available from, one or more of the data sources is unavailable for training the screener language model. For example, data may be generated and stored in one or more of the data sources subsequent to training screener language model. In another example, data available from one or more of the data sources may be unavailable for inclusion in the second training data. In another example, data available from one or more of the data sources prior to training the screener language model may be updated or modified subsequent to training the screener language model.

In some implementations, augmentation data acquisition, including one or more of generating planner language model input data (at 430), obtaining planner language model output data (at 440), determining whether to obtain augmentation data (at 450), and obtaining augmentation data (at 460), may be performed iteratively for one or more iterations, as indicated by the broken directional line (at 465) from obtaining augmentation data (at 460) to generating planner language model input data (at 430).

The dynamic reasoning analysis system generates, or otherwise obtains, planner language model input data (at 430), for the planner language model. The planner language model input data is, or is sent as, a prompt for the planner language model.

The dynamic reasoning analysis system includes the content screening data structure, or one or more portions of the data from the content screening data structure, in the planner language model input data (at 430), such as in an augmentation data section of the planner language model input data.

In some implementations, in the absence of data in, or from, the content screening data structure indicating otherwise, such as in a sequentially first, earliest, or initial iteration, the dynamic reasoning analysis system may include placeholder, or structural, data for the augmentation data section of the planner language model input data. For example, placeholder, or structural, data may include first delimiter data indicating a start of the augmentation data section of the planner language model input data and second delimiter data indicating an end of the augmentation data section of the planner language model input data.

To obtain the planner language model input data (at 430), the dynamic reasoning analysis system generates, or otherwise obtains, current context description data. The current context description data is, or includes, a natural language expression, such as string data, describing context for the language model to respond to a task, or request, indicated in the task data section.

In some implementations, in the absence of data in, or from, the content screening data structure indicating otherwise, such as in a sequentially first, earliest, or initial iteration, the dynamic reasoning analysis system obtains, as the current context description data, natural language data, such as text or string data, such as “You are an intelligent agent that checks if the augmentation data section has all the details available to make a confident decision about the content type of a unit of content. If all the information is available to make a decision and no other context is required, output the content type for the unit of content indicated by the content identifier, and also output the content identifier. Else identify at least one detail that is needed.”.

In some implementations, or iterations, such as iterations other than the sequentially first, earliest, or initial iteration, the dynamic reasoning analysis system obtains the current context description data in accordance with data from the content screening data structure.

For example, content screening data structure may include data indicating that “Rl6uzFj: The unit of content Rl6uzFj is a comment. Is the unit of content Rl6uzFj misinformation?”. and the dynamic reasoning analysis system obtains, as the current context description data, natural language data, such as text or string data, such as “You are an intelligent agent that checks if the augmentation data section has all the information available to make a confident decision whether a comment is misinformation. If all the information is available to make a decision and no other context is required, output Stop and −1. Else identify information that is needed.”.

The dynamic reasoning analysis system includes the current context description data in the planner language model input data, such as subsequent to the augmentation data section of the planner language model input data.

The dynamic reasoning analysis system includes the current context description data in the content screening data structure.

To obtain the planner language model input data (at 430), the dynamic reasoning analysis system generates, or otherwise obtains, task description data. The task description data is, or includes, natural language data, such as text or string data, describing a current request, question, or task.

For example, in the absence of data in, or from, the content screening data structure indicating otherwise, such as in a sequentially first, earliest, or initial iteration, the task description data may be “What is the content type for the unit of content having the content ID”, followed by the content identifier for the current unit of content.

In some implementations, or iterations, such as iterations other than the sequentially first, earliest, or initial iteration, the dynamic reasoning analysis system obtains the task description data in accordance with data from the content screening data structure.

For example, content screening data structure may include “Rl6uzFj: The unit of content Rl6uzFj is a comment. Is the unit of content Rl6uzFj misinformation?”, and the dynamic reasoning analysis system obtains, as the task description data, natural language data, such as text or string data, such as “Is the unit of content Rl6uzFj misinformation?”.

The dynamic reasoning analysis system includes the task description data in the planner language model input data, such as subsequent to the current context description data.

The dynamic reasoning analysis system includes the task description data in the content screening data structure.

The dynamic reasoning analysis system obtains the planner language model output data (at 440). The planner language model output data is, or includes, string data.

To obtain the planner language model output data (at 440), the dynamic reasoning analysis system sends, transmits, or otherwise makes available, the planner language model input data (obtained at 430) to the planner language model.

To obtain the planner language model output data (at 440), the dynamic reasoning analysis system receives, reads, obtains, or otherwise accesses, the planner language model output data from the planner language model, such as responsive to the planner language model input data (obtained at 430).

To obtain the planner language model output data (at 440), the dynamic reasoning analysis system evaluates, parses, or otherwise processes the planner language model output data, such as using regular expressions, to identify one or more defined tokens, wherein a token is a keyword or phrase.

The defined tokens may include an end of planning (EOP) token. For example, the end of planning token may be string data, such as “Stop, −1”. Other data indicating the end of planning token may be used.

The defined tokens may include content type tokens corresponding to the content types, such as a “Comment” token corresponding to the comment content type, or a “Video” token corresponding to the video content type. The dynamic reasoning analysis system may determine that a content type token followed by a content identifier indicates the content type. A content type token followed by data other than a content identifier may be identified as other than indicating a content type.

For example, in a sequentially first, earliest, or initial iteration, the planner language model output data may include content type data, such as string data indicating the content type, for the current unit of content, followed by the content identifier for the current unit of content, followed by “Reasoning: Let's think step by step. The augmentation data section is empty, hence, to start, the output needs the content type identifier and the content identifier.”, and the dynamic reasoning analysis system may evaluate, parse, or otherwise process the planner language model output data to obtain the content type token data.

The defined tokens may include an augmentation data acquisition token indicating that the planner language model output data includes an augmentation data request, which is a request for specified augmentation data. For example, the augmentation data acquisition token may be string data, such as “Call:”.

In some implementations, or iterations, such as iterations other than the sequentially first, earliest, or initial iteration, the planner language model output data may include data indicating an augmentation data acquisition token.

The defined tokens may include an augmentation data source token indicating an augmentation data source for the augmentation data request, corresponding to, such as uniquely identifying, an augmentation data source available in, or accessible by, the dynamic reasoning analysis system.

Subsequent to an augmentation data acquisition token, the planner language model output data may include an augmentation data source token.

The defined tokens may include an augmentation data acquisition parameters token indicating the use of one or more parameters for the augmentation data request. For example, the augmentation data acquisition parameters token may be string data, such as “Param:”.

Subsequent to an augmentation data source token, the planner language model output data may include the augmentation data acquisition parameters token.

The defined tokens may include an augmentation data acquisition parameter phrase delimiter token that indicates that data in the planner language model output data subsequent to an instance of the augmentation data acquisition parameter phrase delimiter token and prior to a subsequent instance of the augmentation data acquisition parameter phrase delimiter token is a parameter phrase. For example, the augmentation data acquisition parameter phrase delimiter token may be string data, such as “'”.

Subsequent to the augmentation data acquisition parameters token, the planner language model output data may include the augmentation data acquisition parameter phrase delimiter token, followed by data indicating a parameter phrase, followed by the parameter phrase, followed by a subsequent instance of the augmentation data acquisition parameter phrase delimiter token.

Subsequent to the augmentation data acquisition parameters token, the planner language model output data may include reasoning data, such as a natural language like reasoning string explaining the reasoning of the planner language model in support of the planner language model output data.

In some implementations, or iterations, the planner language model output data may include the augmentation data acquisition token, followed by an augmentation data source token, followed by the augmentation data acquisition parameters token, followed by the augmentation data acquisition parameter phrase delimiter token, followed by a parameter phrase, followed by the augmentation data acquisition parameter phrase delimiter token, indicating an augmentation data request for the details of the unit of content, followed by reasoning data, such as “Reasoning: Let's think step by step. The augmentation data section indicates that”, followed by the content identifier for the current unit of content, followed by “is a”, followed by content type data for the current unit of content, followed by “The details of the”, followed by content type data for the current unit of content, followed by “are not available in the augmentation data section. Thus, the output needs to request the details of the”, followed by content type data for the current unit of content.

For example, the planner language model output data may include “Call: comment retrieval interface Param: ‘ID: {{Rl6uzFj}}’ Reasoning: Let's think step by step. The augmentation data section indicates that Rl6uzFj is a comment. The details of the comment are not available in the augmentation data section. Thus, the output needs to request the details of the comment.”.

The dynamic reasoning analysis system determines (at 450) whether the planner language model output data (obtained at 440) includes, or indicates, data indicating the end of planning token.

For example, in a sequentially first, earliest, or initial iteration, the dynamic reasoning analysis system may determine that the end of planning token is absent from the planner language model output data.

In some implementations, or iterations, in response to determining (at 450) that the data indicating the end of planning token is absent, omitted, or excluded, from the planner language model output data (obtained at 440), the dynamic reasoning analysis system includes the planner language model output data (obtained at 440), or one or more portions thereof, in the content screening data structure.

For example, in a sequentially first, earliest, or initial iteration, wherein the planner language model output data (obtained at 440) includes the content type data for the current unit of content, and wherein other data, such as data indicating one or more tasks for obtaining the content screening data, is absent, omitted, or unavailable from the planner language model output data and the content screening data structure, the dynamic reasoning analysis system includes, in the content screening data structure, data indicating the content type data, such as text or string data, such as the content identifier for the current unit of content, followed by “: The unit of content”, followed the content identifier for the current unit of content, followed by “is a”, followed by the content type data. For example, the content identifier may be “Rl6uzFj”, the content type may be “comment”, and the dynamic reasoning analysis system may include the string “Rl6uzFj: The unit of content Rl6uzFj is a comment.” in the content screening data structure.

In some implementations, or iterations, in response to determining (at 450) that the data indicating the end of planning token is absent, omitted, or excluded, from the planner language model output data (obtained at 440), the dynamic reasoning analysis system determines that the planner language model output data indicates an express or implicit request to obtain augmentation data (at 460).

In the absence of data in, or from, the content screening data structure indicating otherwise, such as in a sequentially first, earliest, or initial iteration, wherein the planner language model output data (obtained at 440) includes the content type data for the current unit of content, and wherein other data, other than reasoning data, such as data indicating one or more tasks for obtaining the content screening data, is absent, omitted, or unavailable from the planner language model output data and the content screening data structure, the dynamic reasoning analysis system determines that the planner language model output data indicates an express or implicit request to obtain augmentation data including task description data indicating one or more tasks associated with the content type for obtaining the content screening data for the current unit of content.

To obtain the augmentation data including the task description data, the dynamic reasoning analysis system obtains the task description data, such as from a tasks data source. For example, the dynamic reasoning analysis system may include, as the tasks data source, a data structure, such as a list, indicating the task description data for one or more tasks associated with

### Respective Content Types.

In some implementations, the content type may be the comment content type, and the associated, or corresponding, task description data may be, or include, natural language data, such as string data, such as “Is the unit of content”, followed by the content identifier for the current unit of content, followed by “misinformation or self-harm?”. For example, the content identifier may be “Rl6uzFj”, the content type may be “comment”, and the task description data may be “Is the unit of content Rl6uzFj misinformation or self-harm?”. Other tasks may be associated with the comment content type.

In some implementations, the content type may be the video content type, and the associated, or corresponding, task description data may be, or include, natural language data, such as string data, such as “Is the unit of content”, followed by the content identifier for the current unit of content, followed by “misinformation, self-harm, violence, or hate speech?”. For example, the content identifier may be “Rl6uzFj”, the content type may be “video”, and the task description data may be “Is the unit of content Rl6uzFj misinformation, self-harm, violence, or hate speech?”. Other tasks may be associated with the video content type.

In some implementations, such as implementations wherein the current dynamic reasoning analysis input data includes express task data, the dynamic reasoning analysis system omits otherwise obtaining task description data and uses the express task data as the task description data.

In some implementations, or iterations, such as iterations other than the sequentially first, earliest, or initial iteration, the planner language model output data includes an augmentation data request, and the dynamic reasoning analysis system obtains the augmentation data in accordance with the augmentation data request.

To obtain the augmentation data in accordance with the augmentation data request, the dynamic reasoning analysis system sends, transmits, or otherwise makes available the augmentation data request, or one or more portions thereof, to the data source indicated by the augmentation data request, such is expressed in a form compatible with the content data source.

The dynamic reasoning analysis system receives, reads, obtains, or otherwise accesses, the requested augmentation data output by the respective data source in response to the augmentation data request.

For example, the planner language model output data may include the augmentation data request “Call: comment retrieval interface Param: ‘ID: {{Rl6uzFj}}’”, and the dynamic reasoning analysis system may send, transmit, or otherwise make available (call), to the comment retrieval interface, data indicating a request for the details of the comment having the content identifier Rl6uzFj. The dynamic reasoning analysis system may receive, read, obtain, or otherwise access, augmentation data output by the comment retrieval interface in response to the augmentation data request, indicating the details of the comment, such as the text of the comment, such as ‘Sunscreen is not helpful for protecting against skin damage.’ In some implementations, the details of the comment may include data, such as an account identifier, indicating the author of the comment. In some implementations, the details of the comment may include data indicating a content identifier, a content type identifier, or both, for another unit of content associated with comment Rl6uzFj, such as video 3FZjZd, with respect to which the comment pertains.

The dynamic reasoning analysis system includes the augmentation data (obtained at 460) in the content screening data structure, such as subsequent to data previously included the content screening data structure.

In some implementations, or iterations, in response to determining (at 450) that the data indicating the end of planning token is absent, omitted, or excluded, from the planner language model output data (obtained at 440), and subsequent to including the augmentation data the content screening data structure, the dynamic reasoning analysis system iterates generating planner language model input data (at 430), obtaining planner language model output data (at 440), determining whether to obtain augmentation data (at 450), and obtaining augmentation data (at 460), may be performed iteratively for one or more iterations, as indicated by the broken directional line (at 465) from obtaining augmentation data (at 460) to generating planner language model input data (at 430).

In a first example, prior to a first iteration of augmentation data acquisition, the dynamic reasoning analysis system obtains the content identifier “Rl6uzFj”. The dynamic reasoning analysis system obtains an instance of a content screening data structure for obtaining content screening data for a unit of content having the content identifier “Rl6uzFj”.

In the first example, in the first iteration of augmentation data acquisition, augmentation data is absent from the content screening data structure. The dynamic reasoning analysis system generates first planner language model input data including “You are an intelligent agent that checks if the augmentation data section has all the details available to make a confident decision about the content type of a unit of content. If all the information is available to make a decision and no other context is required, output the content type for the unit of content indicated by the content identifier, and also output the content identifier. Else identify at least one detail that is needed. What is the content type for the unit of content having the content ID Rl6uzFj?”. The dynamic reasoning analysis system sends the first planner language model input data to the planner language model.

In response to the first planner language model input data, the dynamic reasoning analysis system obtains, from the planner language model, first planner language model output data indicating “Comment, Rl6uzFj. Reasoning: Let's think step by step. The augmentation data section is empty, hence, to start, output the content category identifier and the content identifier.”.

In response to the first planner language model output data, the dynamic reasoning analysis system obtains task description data associated with the comment content type, including “Is the unit of content Rl6uzFj misinformation?”. The dynamic reasoning analysis system includes the task description data in the content screening data structure.

In the first example, in a second iteration of augmentation data acquisition, the content screening data structure includes the data “Rl6uzFj: The unit of content Rl6uzFj is a comment. Is the unit of content Rl6uzFj misinformation?”. The dynamic reasoning analysis system generates second planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the second planner language model input data to the planner language model.

In response to the second planner language model input data, the dynamic reasoning analysis system obtains, from the planner language model, second planner language model output data indicating “Call: comment retrieval interface Param: ‘ID: {{Rl6uzFj}}’. Reasoning: Let's think step by step. The augmentation data section indicates that Rl6uzFj is a comment. The details of the comment are not available in the augmentation data section. Thus, the output needs to request the details of the comment.”.

In response to the second planner language model output data, the dynamic reasoning analysis system obtains comment detail data for the current unit of content from the comment retrieval interface. The comment detail data indicates that the text of the comment is ‘Sunscreen is not helpful for protecting against skin damage.’ The comment detail data includes an account identifier, oJO3FZ, associated with the author of the comment. The comment detail data includes a content identifier, 3FZjZd, for a video, wherein the comment pertains to the video. The dynamic reasoning analysis system includes the comment detail data in the content screening data structure.

In the first example, in a third iteration of augmentation data acquisition, the content screening data structure includes the data “Rl6uzFj: The unit of content Rl6uzFj is a comment. The text of the comment is ‘Sunscreen is not helpful for protecting against skin damage.’ The author of the comment is oJO3FZ. The comment pertains to a video, 3FZjZd. Is the unit of content Rl6uzFj misinformation?”. The dynamic reasoning analysis system generates third planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the third planner language model input data to the planner language model.

In response to the third planner language model input data, the dynamic reasoning analysis system obtains, from the planner language model, third planner language model output data indicating “Call: policy repository Param: ‘Policy: {{comment misinformation policy}}’, ‘Sections: {{3.4, 4.9}}’. Reasoning: Let's think step by step. The augmentation data section indicates that Rl6uzFj is a comment. The text of the comment is ‘Sunscreen is not helpful for protecting against skin damage.’ The details of the comment misinformation policy are not available in the augmentation data section. Hence, to answer the question, the details of the comment misinformation policy are required.”.

In response to the third planner language model output data, the dynamic reasoning analysis system obtains the text of section 3.4 and 4.9 of a comment misinformation policy from the policy repository. The dynamic reasoning analysis system includes the text of section 3.4 and 4.9 of the comment misinformation policy in the content screening data structure.

In the first example, in a fourth iteration of augmentation data acquisition, the content screening data structure includes the data “Rl6uzFj: The unit of content Rl6uzFj is a comment. The text of the comment is ‘Sunscreen is not helpful for protecting against skin damage.’ The author of the comment is oJO3FZ. The comment pertains to a video, 3FZjZd.”, followed by the text of section 3.4 and 4.9 of the comment misinformation policy, followed by “Is the unit of content Rl6uzFj misinformation?”.

The dynamic reasoning analysis system generates fourth planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the fourth planner language model input data to the planner language model.

In response to the fourth planner language model input data, the dynamic reasoning analysis system obtains, from the planner language model, fourth planner language model output data indicating “Stop, −1. Reasoning: Let's think step by step. The augmentation data section indicates that Rl6uzFj is a comment. The text of the comment is ‘Sunscreen is not helpful for protecting against skin damage.’ The relevant information from the comment misinformation policy is available in the augmentation data section. This comment has all the context to understand the meaning, and therefore video information is not required. Hence, the rater needs to output Stop, −1”.

In a second example, prior to a first iteration of augmentation data acquisition, the dynamic reasoning analysis system obtains the content identifier “Rl6uzFj”. The dynamic reasoning analysis system obtains an instance of a content screening data structure for obtaining content screening data for a unit of content having the content identifier “Rl6uzFj”.

In the second example, in a first iteration of augmentation data acquisition, augmentation data is absent from the content screening data structure. The dynamic reasoning analysis system generates first planner language model input data including “You are an intelligent agent that checks if the augmentation data section has all the details available to make a confident decision about the content type of a unit of content. If all the information is available to make a decision and no other context is required, output the content type for the unit of content indicated by the content identifier, and also output the content identifier. Else identify at least one detail that is needed. What is the content type for the unit of content having the content ID Rl6uzFj?”. The dynamic reasoning analysis system sends the first planner language model input data to the planner language model.

In response to the first planner language model input data, the dynamic reasoning analysis system obtains, from the planner language model, first planner language model output data indicating “Comment, Rl6uzFj. Reasoning: Let's think step by step. The augmentation data section is empty, hence, to start, output the content category identifier and the content identifier.”.

In response to the first planner language model output data, the dynamic reasoning analysis system obtains task description data associated with the comment content type, including “Is the unit of content Rl6uzFj misinformation?”. The dynamic reasoning analysis system includes the task description data in the content screening data structure.

In the second example, in a second iteration of augmentation data acquisition, the content screening data structure includes the data “Rl6uzFj: The unit of content Rl6uzFj is a comment. Is the unit of content Rl6uzFj misinformation?”. The dynamic reasoning analysis system generates second planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the second planner language model input data to the planner language model.

In response to the second planner language model input data, the dynamic reasoning analysis system obtains, from the planner language model, second planner language model output data indicating “Call: comment retrieval interface Param: ‘ID: {{Rl6uzFj}}’ Reasoning: Let's think step by step. The augmentation data section indicates that Rl6uzFj is a comment. The details of the comment are not available in the augmentation data section. Thus, the output needs to request the details of the comment.”.

In response to the second planner language model output data, the dynamic reasoning analysis system obtains comment detail data for the current unit of content from the comment retrieval interface. The comment detail data indicates that the text of the comment is “This product will not prevent skin damage.”. The comment detail data includes an account identifier, oJO3FZ, associated with the author of the comment. The comment detail data includes a content identifier, 3FZjZd, for a video, wherein the comment pertains to the video. The dynamic reasoning analysis system includes the comment detail data in the content screening data structure.

In the second example, in a third iteration of augmentation data acquisition, the content screening data structure includes the data “Rl6uzFj: The unit of content Rl6uzFj is a comment. The text of the comment is ‘This product will not prevent skin damage.’ The author of the comment is oJO3FZ. The comment pertains to a video, 3FZjZd. Is the unit of content Rl6uzFj misinformation?”.

The dynamic reasoning analysis system generates third planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the third planner language model input data to the planner language model.

In response to the third planner language model input data, the dynamic reasoning analysis system obtains, from the planner language model, third planner language model output data indicating “Call: policy repository Param: ‘Policy: {{comment misinformation policy}}’, ‘Sections: {{3.4, 4.9}}’ Reasoning: Let's think step by step. The augmentation data section indicates that Rl6uzFj is a comment. The text of the comment is ‘This product will not prevent skin damage.’ The details of the comment misinformation policy are not available in the augmentation data section. Hence, to answer the question, the details of the comment misinformation policy are required.”.

In response to the third planner language model output data, the dynamic reasoning analysis system obtains the text of section 3.4 and 4.9 of a comment misinformation policy from the policy repository. The dynamic reasoning analysis system includes the text of section 3.4 and 4.9 of the comment misinformation policy in the content screening data structure.

In the second example, in a fourth iteration of augmentation data acquisition, the content screening data structure includes the data “Rl6uzFj: The unit of content Rl6uzFj is a comment. The text of the comment is ‘This product will not prevent skin damage.’ The author of the comment is oJO3FZ. The comment pertains to a video, 3FZjZd.”, followed by the text of section 3.4 and 4.9 of the comment misinformation policy, followed by “Is the unit of content Rl6uzFj misinformation?”.

The dynamic reasoning analysis system generates fourth planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the fourth planner language model input data to the planner language model.

In response to the fourth planner language model input data, the dynamic reasoning analysis system obtains, from the planner language model, fourth planner language model output data indicating “Video: 3FZjZd. Call: Video API Param: ‘ID: {{3FZjZd}}, fields_to_fetch: title’. Reasoning: Let's think step by step. The comment in the augmentation data section is: ‘This product will not prevent skin damage.’ It isn't clear from this comment what reason it is referring to. The comment is in reference to 3FZjZd. 3FZjZd is a video. The details of the video are not available in the augmentation data section. Hence, to understand the comment better, video context is required. Thus, output a request for the title of the video.”.

In response to the fourth planner language model output data, the dynamic reasoning analysis system obtains the title of the video corresponding to content identifier “3FZjZd” from the content hosting search interface, which is “Video title example”. The dynamic reasoning analysis system includes the title of the video in the content screening data structure.

In the second example, in a fifth iteration of augmentation data acquisition, the content screening data structure includes the data “Rl6uzFj: The unit of content Rl6uzFj is a comment. The text of the comment is ‘This product will not prevent skin damage.’ The author of the comment is oJO3FZ. The comment pertains to a video, 3FZjZd. The title of the video is ‘Video title example’”, followed by “Is the unit of content Rl6uzFj misinformation?”.

The dynamic reasoning analysis system generates fifth planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the fifth planner language model input data to the planner language model.

In response to the fifth planner language model input data, the dynamic reasoning analysis system obtains, from the planner language model, fifth planner language model output data indicating “Video: 3FZjZd. Call: Video API Param: ‘ID: {{3FZjZd}}, fields_to_fetch: description’. Reasoning: Let's think step by step. The comment in the augmentation data section is: ‘This product will not prevent skin damage.’ The comment is in reference to 3FZjZd. 3FZjZd is a video. The title of the video is ‘Video title example’. It isn't clear from the title of the video what reason the comment is referring to. Other details of the video are not available in the augmentation data section. Hence, to understand the comment better, other video context is required. Thus, output a request for a description of the video.”.

In response to the fifth planner language model output data, the dynamic reasoning analysis system obtains the description of the video corresponding to content identifier “3FZjZd” from the content hosting search interface, which is “Video description example”. The dynamic reasoning analysis system includes the description of the video in the content screening data structure.

In the second example, in a sixth iteration of augmentation data acquisition, the content screening data structure includes the data “Rl6uzFj: The unit of content Rl6uzFj is a comment. The text of the comment is ‘This product will not prevent skin damage.’ The author of the comment is oJO3FZ. The comment pertains to a video, 3FZjZd. The title of the video is ‘Video title example’. The description of the video is ‘Video description example’”, followed by “Is the unit of content Rl6uzFj misinformation?”.

The dynamic reasoning analysis system generates sixth planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the sixth planner language model input data to the planner language model.

In response to the sixth planner language model input data, the dynamic reasoning analysis system obtains, from the planner language model, sixth planner language model output data indicating “Video: 3FZjZd. Call: Video API Param: ‘ID: {{3FZjZd}}, fields_to_fetch: automatic_speech_transcript’. Reasoning: Let's think step by step. The comment in the augmentation data section is: ‘This product will not prevent skin damage.’ The comment is in reference to 3FZjZd. 3FZjZd is a video. The title of the video is ‘Video title example’. The description of the video is ‘Video description example.’ It isn't clear from the comment, the title of the video, and the description of the video what reason the comment is referring to. Other details of the video are not available in the augmentation data section. Hence, to understand the comment better, other video context is required. Thus, output a request for a transcript of the video.”.

In response to the sixth planner language model output data, the dynamic reasoning analysis system obtains the transcript of the video corresponding to content identifier “3FZjZd” from the content hosting search interface, which is “Study shows wearing sunscreen is not helpful in protecting against skin damage.”. The dynamic reasoning analysis system includes the transcript of the video in the content screening data structure.

In the second example, in a seventh iteration of augmentation data acquisition, the content screening data structure includes the data “Rl6uzFj: The unit of content Rl6uzFj is a comment. The text of the comment is ‘This product will not prevent skin damage.’ The author of the comment is oJO3FZ. The comment pertains to a video, 3FZjZd. The title of the video is ‘Video title example’. The description of the video is ‘Video description example’. The transcript of the video is ‘Study shows wearing sunscreen is not helpful in protecting against skin damage.’”, followed by “Is the unit of content Rl6uzFj misinformation?”.

The dynamic reasoning analysis system generates seventh planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the seventh planner language model input data to the planner language model.

In response to the seventh planner language model input data, the dynamic reasoning analysis system obtains, from the planner language model, seventh planner language model output data indicating “Video: 3FZjZd. Call: Video API Param: ‘ID: {{3FZjZd}}, fields_to_fetch: frames_1fps” Reasoning: Let's think step by step. The comment in the augmentation data section is: ‘This product will not prevent skin damage.’ The comment is in reference to 3FZjZd. 3FZjZd is a video. The title of the video is ‘Video title example’. The description of the video is ‘Video description example’. The transcript of the video is ‘Study shows wearing sunscreen is not helpful in protecting against skin damage.’ It isn't clear from the comment, the title of the video, the transcript of the video, and the description of the video what reason the comment is referring to. Other details of the video are not available in the augmentation data section. Hence, to understand the comment better, other video context is required. Thus, output a request for representative frames of the video.”.

In response to the seventh planner language model output data, the dynamic reasoning analysis system obtains video data (representative video data) including one frame per second of the video corresponding to content identifier “3FZjZd” from the content hosting search interface (Video API). One or more frames of the representative video data show at least one sunscreen product. The dynamic reasoning analysis system includes the video data in the content screening data structure.

In the second example, in an eighth iteration of augmentation data acquisition, the content screening data structure includes the data “Rl6uzFj: The unit of content Rl6uzFj is a comment. The text of the comment is ‘This product will not prevent skin damage.’ The author of the comment is oJO3FZ. The comment pertains to a video, 3FZjZd. The title of the video is ‘Video title example’. The description of the video is ‘Video description example’. The transcript of the video is ‘Study shows wearing sunscreen is not helpful in protecting against skin damage.’, followed by the video data, followed by “Is the unit of content Rl6uzFj misinformation?”.

The dynamic reasoning analysis system generates eighth planner language model input data including the data from the content screening data structure, and data indicating “You are an intelligent agent that checks if the augmentation data section has all the details available to make a confident decision whether a comment is misinformation. If all the information is available to make a decision and no other context is required, output Stop and −1. Else identify at least one detail that is needed.”. The dynamic reasoning analysis system sends the eighth planner language model input data to the planner language model.

In response to the eighth planner language model input data, the dynamic reasoning analysis system obtains, from the planner language model, eighth planner language model output data indicating “Stop, −1. Reasoning: Let's think step by step. The augmentation data section indicates that Rl6uzFj is a comment. The comment in the augmentation data section is: ‘This product will not prevent skin damage.’ The comment is in reference to 3FZjZd. 3FZjZd is a video. The title of the video is ‘Video title example’. The description of the video is ‘Video description example’. The transcript of the video is ‘Study shows wearing sunscreen is not helpful in protecting against skin damage.’ Representative video data is available in the augmentation data section. The representative video data shows an image of a sunscreen product. The relevant information from the comment misinformation policy is available in the augmentation data section. This augmentation data section has all the context to understand the meaning. Hence, the rater needs to output Stop, −1”.

In some implementations, or iterations, in response to determining (at 450) that the planner language model output data (obtained at 440) includes the end of planning token (YES at 450), the dynamic reasoning analysis system obtains screener language model input data (at 470).

For example, in an iteration, other than the sequentially first, earliest, or initial iteration, for a comment type unit of content having the content identifier “Rl6uzFj”, the planner language model output data may include the end of planning token, such as “Stop, −1.”, followed by reasoning data, such as “Reasoning: Let's think step by step. The augmentation data section indicates that Rl6uzFj is a comment. The comment in the augmentation data section is: ‘Sunscreen is not helpful for protecting against skin damage.’ This comment has all the context to understand the meaning, and therefore other information is not required. Hence, output Stop, −1”.

To obtain the screener language model input data (at 470), the dynamic reasoning analysis system includes the augmentation data from the content screening data structure in the screener language model input data. The augmentation data includes data that is otherwise unavailable to the screener language model, which includes differing from the second training data.

To obtain the screener language model input data (at 470), the dynamic reasoning analysis system includes context description data in the screener language model input data.

For example, the dynamic reasoning analysis system obtains, as context description data for the screener language model input data, natural language data, such as text or string data, such as “You are an intelligent agent which uses the augmentation data provided to answer the questions. If the unit of content in question is a channel, use the channel title and channel description information in accordance with the policy to answer. If the unit of content is a video, use the speech transcript as needed by the policy to construct the response. If the unit of content is a comment, use the comment text, and the information about the video on which that comment was made, as recommended by the policy to make a determination. Think step by step. Don't just mention each information, rather construct a cohesive and precise response based on that information. Given these guidelines, answer this question.”.

To obtain the screener language model input data (at 470), the dynamic reasoning analysis system includes the task description data in the screener language model input data.

In some implementations, the content type may be the comment content type, and the associated, or corresponding, task description data may be, or include, natural language data, such as string data, such as “Is the unit of content”, followed by the content identifier for the current unit of content, followed by “misinformation?”. For example, the content identifier may be “Rl6uzFj”, the content type may be “comment”, and the task description data may be “Is the unit of content Rl6uzFj misinformation?”.

The dynamic reasoning analysis system obtains screener language model output data (at 480). The screener language model output data is, or includes, string data.

To obtain the screener language model output data (at 480), the dynamic reasoning analysis system sends, transmits, or otherwise makes available, the screener language model input data (obtained at 470) to the screener language model.

The screener language model uses the screener language model input data, including the augmentation data, to generate, or otherwise output, screener language model output data.

To obtain the screener language model output data (at 480), the dynamic reasoning analysis system receives, reads, obtains, or otherwise accesses, the screener language model output data from the screener language model, such as responsive to the screener language model input data (obtained at 470).

For example, the screener language model output data may include natural language like text, or string data, responsive to the task description data, such as data indicating a screener language model generated determination responsive to the task description data. In some implementations, the screener language model output data may include natural language like text, or string data, indicating screener language model generated reasoning in support of the screener language model generated determination. In some implementations, the screener language model output data may include natural language like text, or string data, indicating one or more actions for the dynamic reasoning analysis system to perform with respect to the current unit of content in accordance with the screener language model generated determination responsive to the task description data.

In an example, the task description data may be “Is the unit of content Rl6uzFj misinformation?”, and the screener language model output data may include “Yes. Label: Misinformation. The comment is misinformation because it makes false claims about the effectiveness of sunscreen for preventing skin damage.”.

The dynamic reasoning analysis system outputs the content screening data (at 490) including the screener language model output data, or one or more portions thereof.

In the examples of text or string data, such as natural language data, described herein some text, such as punctuation, whitespace, or other structural elements, may be omitted for simplicity.

Although described herein with respect to content screening, the dynamic reasoning analysis system may be used for other tasks, which may include using other data sources.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in some implementations, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application and are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method, comprising:
content screening, by a dynamic reasoning analysis system, a unit of content, wherein the content screening includes:
obtaining current dynamic reasoning analysis input data, wherein the current dynamic reasoning analysis input data includes a content identifier for the unit of content;
obtaining a content screening data structure;
identifying a planner language model trained using planner training data, wherein augmentation data sources are available to the dynamic reasoning analysis system, and wherein at least some data available from the augmentation data sources differs from the planner training data;
one or more iterations of obtaining augmentation data, wherein a respective iteration of obtaining augmentation data comprises including current augmentation data as augmentation data in the content screening data structure;
obtaining screener language model input data including the augmentation data from the content screening data structure;
sending the screener language model input data to a screener language model;
obtaining, from the screener language model, in response to the screener language model input data, content screening data for the unit of content, wherein the content screening data includes data indicating an action for the unit of content; and
performing the action.

2. The method of claim 1, wherein a respective iteration of obtaining augmentation data includes:
generating planner language model input data in accordance with the current dynamic reasoning analysis input data and data from the content screening data structure;
sending the planner language model input data to the planner language model;
obtaining, from the planner language model, in response to the planner language model input data, planner language model output data;
determining whether the planner language model output data includes an end of planning token;
in response to determining that the planner language model output data omits the end of planning token, obtaining, in accordance with the planner language model output data, the current augmentation data from a current augmentation data source from the augmentation data sources, wherein the planner language model output data indicates the current augmentation data source; and
in response to determining that the planner language model output data omits the end of planning token, identifying the screener language model trained using second training data, wherein at least some data available from the augmentation data sources differs from the second training data.

3. The method of claim 1, wherein the unit of content is a text string, account data, a content collection, a video, an image, or an audio clip.

4. The method of claim 3, wherein the content collection is a playlist or a channel.

5. The method of claim 1, wherein the content screening data includes a language model generated natural language description of reasoning in support of the data indicating the action for the unit of content.

6. The method of claim 1, wherein performing the action includes:
labeling the unit of content in accordance with a language model generated label from the content screening data.

7. The method of claim 1, wherein the content screening data includes confidence data.

8. The method of claim 7, wherein the content screening data includes a natural language description of reasoning in support of confidence data.

9. The method of claim 7, wherein the content screening includes:
determining whether the confidence data indicates a confidence value that is greater than a defined threshold.

10. The method of claim 9, wherein performing the action includes:
performing the action in response to determining that the confidence value is greater than the defined threshold.

11. The method of claim 10, wherein:
the defined threshold is a rejection threshold; and
performing the action includes:
removing the unit of content from a content hosting system; or
including data in the content hosting system indicating that accessing the unit of content is prohibited.

12. The method of claim 10, wherein:
the defined threshold is an approval threshold; and
performing the action includes:
omitting removing the unit of content from a content hosting system;
including the unit of content in the content hosting system; or
including data in the content hosting system indicating that accessing the unit of content is permitted.

13. A dynamic reasoning analysis system, comprising:
a processor; and
a memory storing instructions that, when executed by the processor, cause the dynamic reasoning analysis system to screen a unit of content, wherein, to screen the unit of content, the processor executes the instructions to:
obtain current dynamic reasoning analysis input data, wherein the current dynamic reasoning analysis input data includes a content identifier for the unit of content;
obtain a content screening data structure;
identify a planner language model trained using planner training data, wherein augmentation data sources are available to the dynamic reasoning analysis system, and wherein at least some data available from the augmentation data sources differs from the planner training data;
iteratively obtain augmentation data, wherein, to perform a respective iteration, the processor executes the instructions to include current augmentation data as augmentation data in the content screening data structure;
obtain screener language model input data that includes the augmentation data from the content screening data structure;
send the screener language model input data to a screener language model;
obtain, from the screener language model, in response to the screener language model input data, content screening data for the unit of content, wherein the content screening data includes data indicating an action for the unit of content; and
perform the action.

14. The dynamic reasoning analysis system of claim 13, wherein, to perform a respective iteration, the processor executes the instructions to:
generate planner language model input data in accordance with the current dynamic reasoning analysis input data and data from the content screening data structure;
send the planner language model input data to the planner language model;
obtain, from the planner language model, in response to the planner language model input data, planner language model output data;
determine whether the planner language model output data includes an end of planning token;
in response to a determination that the planner language model output data omits the end of planning token, obtain, in accordance with the planner language model output data, the current augmentation data from a current augmentation data source from the augmentation data sources, wherein the planner language model output data indicates the current augmentation data source; and
in response to the determination that the planner language model output data omits the end of planning token, identify the screener language model trained using second training data, wherein at least some data available from the augmentation data sources differs from the second training data.

15. The dynamic reasoning analysis system of claim 13, wherein the unit of content is a text string, account data, a content collection, a video, an image, or an audio clip.

16. The dynamic reasoning analysis system of claim 15, wherein the content collection is a playlist or a channel.

17. The dynamic reasoning analysis system of claim 13, wherein the content screening data includes a language model generated natural language description of reasoning in support of the data indicating the action for the unit of content.

18. The dynamic reasoning analysis system of claim 13, wherein, to perform the action, the processor executes the instructions to:
label the unit of content in accordance with a language model generated label from the content screening data;
remove the unit of content from a content hosting system;
include data in the content hosting system indicating that accessing the unit of content is prohibited;
omit removing the unit of content from the content hosting system;
include the unit of content in the content hosting system; or
include data in the content hosting system indicating that accessing the unit of content is permitted.

19. A non-transitory computer-readable storage medium storing instructions that, when executed by at least one processor, cause the at least one processor to perform:
content screening, by a dynamic reasoning analysis system, a unit of content, wherein the content screening includes:
obtaining current dynamic reasoning analysis input data, wherein the current dynamic reasoning analysis input data includes a content identifier for the unit of content;
obtaining a content screening data structure;
identifying a planner language model trained using planner training data, wherein augmentation data sources are available to the dynamic reasoning analysis system, and wherein at least some data available from the augmentation data sources differs from the planner training data;
one or more iterations of obtaining augmentation data, wherein a respective iteration of obtaining augmentation data comprises including current augmentation data as augmentation data in the content screening data structure;
obtaining screener language model input data including the augmentation data from the content screening data structure;
sending the screener language model input data to a screener language model;
obtaining, from the screener language model, in response to the screener language model input data, content screening data for the unit of content, wherein the content screening data includes data indicating an action for the unit of content; and
performing the action.

20. The non-transitory computer-readable storage medium of claim 19, wherein a respective iteration of obtaining augmentation data includes:
generating planner language model input data in accordance with the current dynamic reasoning analysis input data and data from the content screening data structure;
sending the planner language model input data to the planner language model;
obtaining, from the planner language model, in response to the planner language model input data, planner language model output data;
determining whether the planner language model output data includes an end of planning token;
in response to determining that the planner language model output data omits the end of planning token, obtaining, in accordance with the planner language model output data, the current augmentation data from a current augmentation data source from the augmentation data sources, wherein the planner language model output data indicates the current augmentation data source; and
in response to determining that the planner language model output data omits the end of planning token, identifying the screener language model trained using second training data, wherein at least some data available from the augmentation data sources differs from the second training data.
